(19) United States
(12) Patent Application Publication
(10) Pub. No.: US 2013/0125750 A1
(43) Pub. Date: May 23, 2013

(54) Reduction of Mercury Emissions From Cement Plants

(71) Applicants: Ronald R. Landreth, Baton Rouge, LA (US); Xin Liu, Baton Rouge, LA (US); Jon E. Miller, Baton Rouge, LA (US); Arlen E. Overholt, Twinsburg, OH (US); Zhong Tang, Baton Rouge, LA (US)

(72) Inventors: Ronald R. Landreth, Baton Rouge, LA (US); Xin Liu, Baton Rouge, LA (US); Jon E. Miller, Baton Rouge, LA (US); Arlen E. Overholt, Twinsburg, OH (US); Zhong Tang, Baton Rouge, LA (US)

(73) Assignee: ALBEMARLE CORPORATION, Baton Rouge, LA (US)

(21) Appl. No.: 13/695,648

(22) PCT Filed: Apr. 27, 2011
(86) PCT No.: PCT/US11/34176

§ 371 Date: Jan. 3, 2013

Related U.S. Application Data
(60) Provisional application No. 61/331,238, filed on May 4, 2010.

(51) Int. Cl. B01D 53/12

(52) U.S. Cl. CPC B01D 53/12
USPC 95/108; 96/132

(57) ABSTRACT

This invention provides methods for reduction of mercury emissions from cement plants. In one method, a powdered activated carbon sorbent is injected into a gas stream of a cement plant at one or more points after the kiln and before the particulate collection device of the cement plant. Also provided is an apparatus for decreasing emissions from a cement plant, which apparatus comprises two or more beds in a series comprising a first bed which is a moving bed, and one or more remaining beds which are fixed beds, each fixed bed comprising at least one sorbent which is able to absorb at least one of mercury, hydro-carbons, and hydrochloric acid. Another method for reducing emissions from a cement plant employs the apparatus just described.

### TECHNICAL FIELD

This invention relates to reduction of mercury emissions from cement plants.

### BACKGROUND

Research into sources of mercury emissions in the U.S. has resulted in the identification of cement producing facilities as significant emission source of mercury. Currently, cement plants are the fourth largest source of mercury emissions in the U.S. The U.S. Environmental Protection Agency (EPA) has proposed a rule to limit mercury emissions from cement plants. The proposed rule sets forth the first limits on mercury emissions from existing cement plants and strengthens the limits for new plants. The proposed rule sets mercury emission limits for existing sources at 26 pounds of mercury per million tons of feed (−13 kg/million tons) or 43 pounds of mercury per million tons of clinker produced (−21.5 kg/million tons). For new cement plants, the mercury emission limit is 14 pounds of mercury per million tons of clinker produced (−7.0 kg/million tons). The proposed rule is set to take effect in 2013. The EPA estimates that when the rule is fully implemented, annual emissions of mercury from cement plants will be reduced by at least 81%.

In addition, the rule proposed by the EPA will also regulate the emission of total hydrocarbons (THC), particulate matter (PM), and hydrochloric acid from cement plants. For these emissions, the limits in the proposed rule require pollution controls, not just management practices. The limit on THC is 7 parts per million (ppm, volume); particulate matter is limited to 0.085 pounds per ton of clinker produced (−0.43 kg/ton); for HCl, 2 ppm (volume) is the limit

It is known that activated carbon can be injected into a gas stream containing mercury vapor. When mercury vapor contacts activated carbon particles, the mercury is captured and held by the activated carbon particles. The particles are then collected by a particulate collection device, such as an electrostatic precipitator or a baghouse filter. The mercury captured by the activated carbon particles appears to be stably bonded to the particles. In cement plant operations, the particulates captured by the control device are normally recycled to the cement production process. However, activated carbon is unsuitable for many applications of the produced cement.

Relatively inexpensive and yet effective ways to reduce mercury emissions as well as emissions of particulate matter, total hydrocarbons, and hydrochloric acid from cement plants is quite desirable.

### SUMMARY OF THE INVENTION

This invention provides methods for reducing the emissions of mercury and other substances, including particulate matter, total hydrocarbons, and hydrochloric acid at relatively low cost. The methods provided herein can be incorporated into existing cement plants without requiring extensive reconfiguration.

One embodiment of this invention is a method for reducing mercury emissions from a cement plant comprising at least a kiln and a particulate collection device. The method comprises injecting a powdered activated carbon sorbent into a gas stream of the cement plant at one or more points after the kiln and before the particulate collection device of the cement plant. The injected sorbent, which has an Acid Blue 80 Index of less than about 30 milligrams per gram of sorbent (prior to any optional post-treatment with ozone or nitric acid), does not travel through the kiln.

Another embodiment of this invention is an apparatus for decreasing emissions from a cement plant comprising at least a particulate collection device and a stack. The apparatus comprises two or more beds in a series comprising

a first bed which is a moving bed, and

one or more remaining beds which are fixed beds, each fixed bed comprising at least one sorbent which is able to absorb at least one of mercury, hydrocarbons, and hydrochloric acid.

Still another embodiment of this invention is a method for reducing emissions of (i) particulate matter, and (ii) at least one of mercury, hydrochloric acid, and hydrocarbons from a cement plant, which method employs the apparatus just described.

### BRIEF DESCRIPTION OF THE DRAWINGS

FIG. 1 is a schematic diagram of a generalized cement plant configuration.

FIG. 2 is a schematic diagram of the apparatus of the second aspect of the invention.

FIG. 3A is a schematic diagram of the placement of the apparatus of the second aspect of the invention when a bypass duct is not present.

FIG. 3B is a schematic diagram of the placement of the apparatus of the second aspect of the invention when a bypass duct is present.

These and other embodiments and features of this invention will be still further apparent from the ensuing description, drawings, and appended claims.

### FURTHER DETAILED DESCRIPTION OF THE INVENTION

The configurations of cement plants vary, but have several features in common. A generalized cement plant configuration showing pertinent parts is shown in FIG. 1. In cement plants having a raw material mill and a preheater tower, material from the raw material mill 2 (raw mill) is fed to the top of the preheater tower 4 (sometimes called a precalciner tower) and from the preheater tower 4 into the kiln 6 Clinker is produced in the kiln, and is discharged from the kiln A gas stream 8a exits from the kiln 6. The gas stream 8a enters the bottom of the preheater tower 4 and exits from the top of the preheater tower 4. The gas stream 8b is then cooled, usually by water, often in a conditioning tower. When the raw mill 2 is operating, the cooled gas stream 8b is recycled to the raw mill 2; when the raw mill is not operating, the cooled gas stream 8b instead travels to a particulate collection device 10. After passing through the particulate collection device 10, the gas stream 8c exits the cement plant by traveling through the stack 12.

The Figures are not intended to be construed as limiting the inventions. For example, the present inventions apply to cement plants that do not have a raw material mill and/or a preheater tower.

In the practice of the present invention, the reduction of mercury emissions employs a sorbent which is an activated carbon sorbent, preferably a bromine-containing activated carbon sorbent. Bromine-containing activated carbon sorbents are formed by treating (contacting) the sorbent with an effective amount of a bromine-containing substance for a sufficient time to increase the ability of the activated carbon to adsorb mercury and mercury-containing compounds. Suitable bromine-containing substances include dissolved metal bromides, especially bromides of K⁺, Na⁺, or NH₄⁺; hydrogen halide salts; elemental bromine, and hydrogen bromide. Preferred bromine-containing substances are elemental bromine (Br₂) and/or hydrogen bromide (HBr); preferably, the elemental bromine and/or hydrogen bromide are in gaseous form when brought into contact with the activated carbon sorbent. Such contacting of the activated carbon sorbent and a bromine-containing substance significantly increases the sorbent's ability to absorb mercury and mercury-containing compounds.

Even low levels of bromination appear to increase the mercury-removal performance of activated carbon sorbents. While over 30 wt % of bromine can be adsorbed into some powdered activated carbons, for example, significant increases in mercury absorptivity are observed with only about 1 wt % of bromine in the activated carbon sorbent. Greater degrees of bromination do correlate with greater maximum mercury capacities for a particular sorbent. However, the optimum level of bromine-containing substance to combine with the activated carbon sorbent varies with the particular situation. Brominating to about 1 wt % provides a highly-capable mercury sorbent, although a sorbent material having about 5 wt % bromine performs better and may be preferable. Brominating to about 15 wt % bromine generally produces an even more capable mercury sorbent, but there is a greater possibility that some degree of bromine may evolve from the sorbent under some circumstances. Mercury sorbents with higher bromine concentrations take longer to produce and cost more. Additional considerations for forming bromine-containing activated carbon are found in U.S. Pat. No. 6,953,494. A preferred bromine-containing activated carbon is available commercially from Albemarle Corporation as B-PAC™.

In some embodiments of this invention, after capturing mercury, the sorbent is incorporated into the cement. The incorporation of mercury-containing sorbents (e.g., fly ash) into concrete is acceptable and practiced. However, most types of activated carbon are unsuitable for incorporation into cement, before or after mercury capture, as the absorptive properties of the activated carbon interfere with production of concrete from cement. Recently, it has been discovered that activated carbon sorbents that have been manufactured in such a way so as to possess certain properties are suitable for incorporation into concrete. These properties are best indicated by an Acid Blue 80 Index, or ABI. The ABI is a relative measure of the amount of a particular dye, Acid Blue 80 (CAS® registry number 4474-24-2), that the activated carbon sorbent adsorbs from a standard solution of Acid Blue 80. It can be quantitatively determined using a standard UV-visible light spectrophotometry analysis technique, and is determined prior to any optional post-treatment with ozone or nitric acid. To be suitable for use in typical concretes, activated carbon sorbents must have a sufficiently low ABI, below about 30 milligrams of Acid Blue 80 per gram of sorbent, preferably below about 15 mg/g sorbent. Generally, the ABI is in the range of about 0.1 mg/g sorbent to below about 30 mg/g sorbent.

Activated carbon sorbents having an ABI below about 30 mg/g sorbent are formed by activation or re-activation in an environment in which free oxygen is present, such as air, rather than with steam or carbon dioxide. Suitable carbon sources for forming low-ABI activated carbon include, but are not limited to, lignite, anthracite and low-volatile bituminous coal; anthracite is preferred. A low-ABI activated carbon sorbent can also be produced by steam activation, by using anthracite or low-volatile bituminous coal and carefully controlling the activation.

Treating the low-ABI activated carbon with a bromine-containing substance to increase the mercury capture effectiveness of the carbon can be performed, and is preferred. See published International Patent Application No. WO 2008/064360 for further information regarding activated carbon sorbents that are compatible with concrete. A preferred bromine-containing activated carbon sorbent that is compatible with concrete is available commercially from Albemarle Corporation as C-PAC™.

### First Aspect of the Invention

In the embodiments of this aspect of the invention, the activated carbon sorbent is powdered and has an ABI below about 30 mg/g sorbent. The activated carbon sorbent is injected into the gas stream of the cement plant, and is carried with the other particulates and gases through the cement plant, eventually to the particulate collection device, where the sorbent is collected along with the other particulates. The sorbent does not travel through the kiln, since conditions in the kiln destroy the absorptive properties of the powdered activated carbon sorbent. In cement plants having a preheater tower, the sorbent optionally and preferably is not injected at a point before the preheater tower or into the preheater tower. Often, conditions in the preheater tower are such that the absorptive properties of the powdered activated carbon sorbent are destroyed. Once the sorbent has been injected and travels through the cement plant, the sorbent can travel through the preheater tower.

As mentioned above, for this first aspect of the invention, the activated carbon sorbent is powdered, and has an Acid Blue 80 Index of less than about 30 milligrams per gram of sorbent, preferably below about 15 mg/g sorbent, prior to any optional post-treatment with ozone or nitric acid. Generally, the ABI is in the range of about 0.1 mg/g sorbent to below about 30 mg/g sorbent. The sorbent is preferably formed from anthracite or low-volatile bituminous coal; more preferably, from anthracite.

In preferred embodiments, the activated carbon sorbent has been treated with an effective amount of a bromine-containing substance for a sufficient time to increase the ability of the activated carbon to absorb mercury and/or mercury-containing compounds. Suitable bromine-containing substances are described above. Preferably, the bromine-containing substance comprises elemental bromine and/or hydrogen bromide; more preferably, elemental bromine Treatment of the sorbent with bromine-containing substance(s) is preferably conducted such that the sorbent has about 0.1 to about 15 wt % bromine.

In particularly preferred embodiments, the powdered activated carbon is formed from anthracite or low-volatile bituminous coal, has been treated with an effective amount of elemental bromine and/or hydrogen bromide for a sufficient time to increase the ability of the activated carbon to adsorb mercury and mercury-containing compounds such that the sorbent has about 0.1 to about 15 wt % bromine; more preferably, such sorbent has an Acid Blue 80 Index below about 15 milligrams per gram of sorbent.

In the method of this aspect of the invention, the powdered activated carbon sorbent is injected into a gas stream of a cement plant at one or more points after the kiln and before the particulate collection device of said cement plant. The injection point(s) for the sorbent is after the kiln and before the particulate collection device. Within these parameters, it is recommended that the sorbent be injected to maximize both the residence time of the sorbent in the system and the best distribution of the sorbent in the system, in order to provide the greatest opportunity for contact of the sorbent and the mercury and/or mercury-containing compounds. Due to the wide variation in cement plant configurations, the optimum injection point(s) will vary from cement plant to cement plant.

The activated carbon sorbents are typically injected at a rate of about 0.5 to about 20 lb/MMacf (8×10⁻⁶ to 320×10⁻⁶ kg/m³). Preferred injection rates are about 4 to about 18 lb/MMacf (16×10⁻⁶ to 288×10⁻⁶ kg/m³); more preferred are injection rates of about 5 to about 15 lb/MMacf (80×10⁻⁶ to 240×10⁻⁶ kg/m³), though it is understood that the preferred injection rate varies with the particular system configuration.

Without wishing to be bound by theory, it is believed that the activated carbon sorbent comes into contact with mercury and/or mercury-containing compounds, which are then absorbed by the activated carbon sorbent. The sorbent travels from the injection point through the cement plant and is collected, along with other particulates, in the particulate collection device of the cement plant. The collected particulates, including the powdered activated carbon sorbent, end up in the cement product.

### Second Aspect of the Invention

In the embodiments of this aspect of the invention, an apparatus for decreasing emissions from a cement plant is provided. The apparatus comprises two or more beds in a series comprising a first bed which is a moving bed, and one or more remaining beds which are fixed beds, each fixed bed comprising at least one sorbent which is able to absorb at least one of mercury, hydrochloric acid, and hydrocarbons.

The moving bed of the apparatus captures particulate matter that passes through the particulate collection device, which further reduces the emission of particulate matter from the cement plant. In addition, the capture of particulate matter by the moving bed protects the sorbent(s) in the fixed bed(s) of the apparatus such that the fixed bed sorbents can perform for longer periods of time without replacement or re-activation of the sorbent therein.

Suitable sorbents to capture the particulate matter in the moving bed are granular sorbents generally having a size range between about 5 and about 20 U.S. Mesh (0.85 to 4 mm), preferably about 5 to about 7 U.S. Mesh (2.8 to 4 mm) Examples of such sorbents include sand, stone particles, ceramic, glass beans, quartz, and activated carbon. Activated carbon for the moving bed includes unaltered activated carbon and chemically-treated activated carbon, including bromine- or sulfur-impregnated activated carbons.

There can be one or more fixed beds in the apparatus, but there is always at least one fixed bed. Usually, there is a sorbent for reducing one type of emission in one fixed bed. For example, a mercury sorbent is in one fixed bed, an HCl sorbent is in another, separate fixed bed. While more than one sorbent can be placed in the same fixed bed, it is often preferred to have the different sorbents in separate fixed beds, so that they can be recycled or re-activated according to their different requirements. It is possible to have more than one fixed bed of sorbent for each substance for which emission reduction is desired, although this is not believed to be necessary.

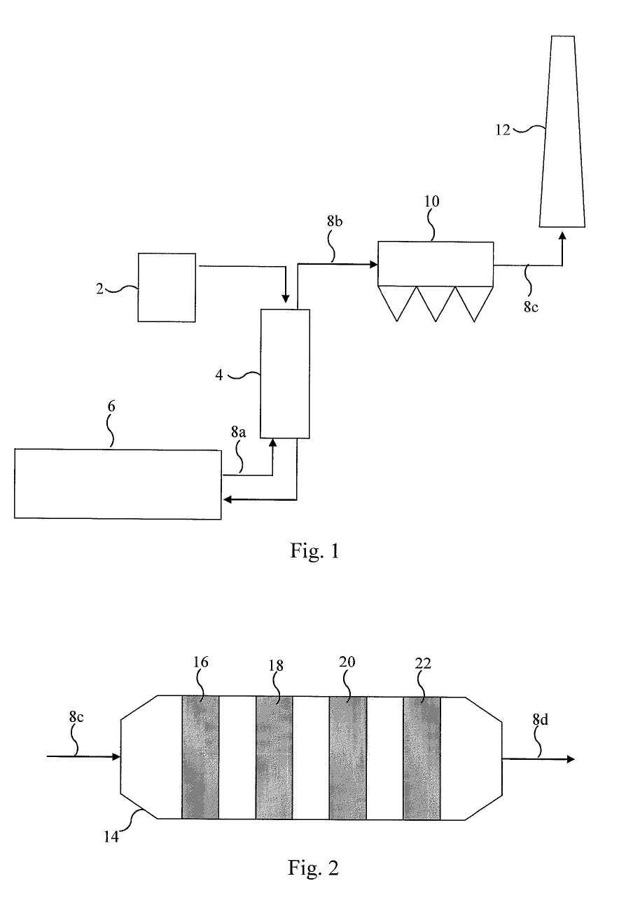

Turning now to FIG. 2, an apparatus 14 is shown, with a gas stream 8c from the particulate collection device (not shown in FIG. 2) entering apparatus 14, and gas stream 8d exits apparatus 14 to the stack (not shown in FIG. 2). Bed 16 in FIG. 2 is a moving bed. Beds 18, 20, and 22 are fixed beds, one or more of which is optionally not present, as long as at least one of fixed beds 18, 20, and 22 is present in apparatus 14. It is clear from FIG. 2 that the gas stream 8c enter apparatus 14, travels through moving bed 16, and all of the fixed beds that are present in apparatus 14, and exits apparatus 14 as gas stream 8d, which travels to the stack.

When a fixed bed is for reduction of mercury emissions, suitable sorbents include activated carbon sorbents, activated carbon fiber sorbents, and mineral sorbents (e.g., silica or zeolites). The mercury sorbent is preferably an activated carbon sorbent. Granulated or powdered activated carbon can be employed; granulated activated carbon is preferred. In preferred embodiments, the activated carbon sorbent has been treated with an effective amount of a bromine-containing substance for a sufficient time to increase the ability of the activated carbon to absorb mercury and/or mercury-containing compounds. Suitable bromine-containing substances are described above. Preferably, the bromine-containing substance comprises elemental bromine and/or hydrogen bromide; more preferably, elemental bromine Treatment of the sorbent with bromine-containing substance(s) is preferably conducted such that the sorbent has about 0.1 to about 15 wt % bromine

One of the advantages of this aspect of the invention is that it is not necessary to employ an activated carbon sorbent having an ABI below about 30 mg/g sorbent, unless the used sorbent will be incorporated into cement after removal of sorbent from the fixed bed.

For total hydrocarbon emission reduction, sorbents generally include activated carbon sorbents, activated carbon fiber sorbents, and polymeric sorbents. Sorbents for HCl reduction typically include calcium-based sorbents, such as calcium oxide, calcium hydroxide, and calcium carbonate, and sodium-based sorbents, such as sodium carbonate and sodium aluminate.

In the methods of this aspect of the invention, emissions of (i) particulate matter, and (ii) at least one of mercury, hydrochloric acid, and hydrocarbons from a cement plant are reduced. The method comprises placing an apparatus as just described after the particulate collection device of the cement plant and before the stack of the cement plant such that a gas stream can enter the apparatus from the particulate collection device, travel through and exit the apparatus to the stack.

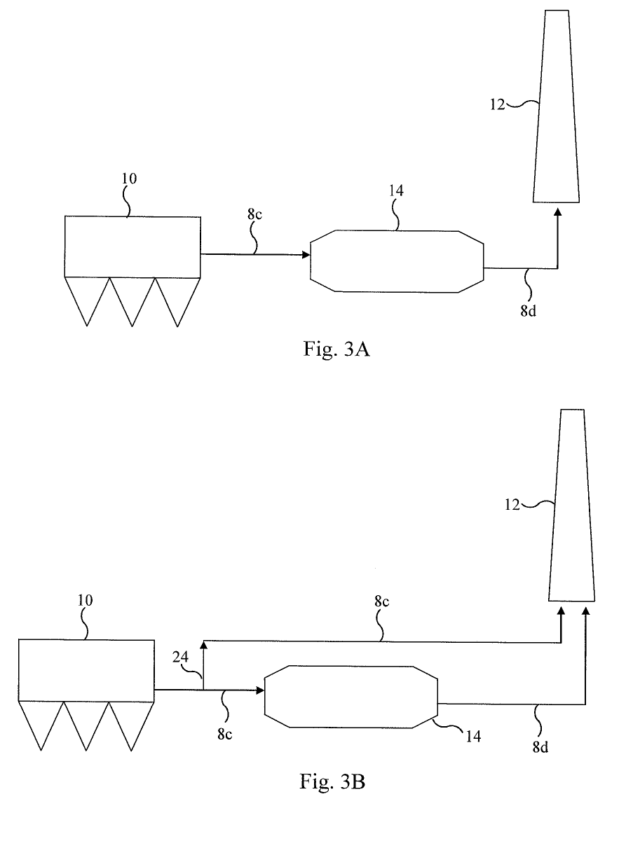

FIG. 3A shows the placement of the apparatus when a bypass duct is not present. Apparatus 14 is placed after the particulate collection device 10 and before the stack 12. Gas stream 8c exits the particulate collection device 10 and enters apparatus 14. Gas stream 8d exits apparatus 14 and enters stack 12, from which the gas stream exits the cement plant.

For some cement plants, emissions are high enough that use of the apparatus of this invention is desirable or necessary at all times. This situation is illustrated in FIG. 3A.

When the emissions from a cement plant are variable, especially in a predictable way, the gas stream can be sent through the apparatus as needed. Thus, when emissions are higher, the gas stream is sent through the apparatus; when emissions are lower, the gas stream can bypass the apparatus.

An example of a situation in which the emissions from a cement plant are variable in a predictable way occurs in cement plants having a raw mill Emissions are usually lower when the raw mill is operating, and are higher when the raw mill is not operating. Depending on the emission levels when the raw mill is operating, it may not be necessary to route the gas stream exiting the particulate collection device through the apparatus. Thus, in some cement plants, the apparatus can be bypassed when the raw mill is operating. In such cement plants, when the raw mill is operating, the gas stream can travel via a bypass duct from the particulate collection device to the stack. However, when the raw mill is not operating, emissions are often higher, and sending the gas stream through the apparatus is usually desired or necessary.

FIG. 3B shows the placement of the apparatus when a bypass duct is present. Apparatus 14 is placed after the particulate collection device 10 and before the stack 12, but not in line with the bypass duct 24. Gas stream 8c exits the particulate collection device 10 and either enters apparatus 14, or travels through bypass duct 24 to the stack 12, from which the gas stream exits the cement plant. When gas stream 8c enters apparatus 14, gas stream 8d exits apparatus 14 and enters stack 12, from which the gas stream exits the cement plant.

The effect of the use of the method of this aspect of the invention is the further reduction of particulate matter and other emissions from the cement plant. The moving bed captures additional particulate matter, and the sorbent(s) in the fixed bed(s) capture at least one of mercury, hydrochloric acid, and total hydrocarbons.

Further embodiments of the invention include, without limitation:

A) A method for reducing mercury emissions from a cement plant comprising at least a kiln and a particulate collection device, which method comprises

injecting a powdered activated carbon sorbent into a gas stream of said cement plant at one or more points after the kiln and before the particulate collection device of said cement plant, with the proviso that the sorbent does not travel through the kiln,

wherein said activated carbon has an Acid Blue 80 Index of less than about 30 milligrams per gram of sorbent prior to any optional post-treatment with ozone or nitric acid.

B) A method as in A) wherein said activated carbon sorbent has been treated with an effective amount of a bromine-containing substance for a sufficient time to increase the ability of the activated carbon to adsorb mercury and mercury-containing compounds, wherein said bromine-containing substance comprises elemental bromine, wherein the sorbent is formed from anthracite or low-volatile bituminous coal, and wherein said sorbent has about 0.1 to about 15 percent by weight bromine.

C) A method as in B) wherein said sorbent has an Acid Blue 80 Index below about 15 milligrams per gram of sorbent.

D) A method as in A) wherein the sorbent is formed from anthracite or low-volatile bituminous coal, and wherein said sorbent has an Acid Blue 80 Index below about 15 milligrams per gram of sorbent.

E) A method as in D) wherein the sorbent is formed from anthracite.

F) A method as in A) wherein said activated carbon sorbent has been treated with an effective amount of a bromine-containing substance for a sufficient time to increase the ability of the activated carbon to adsorb mercury and mercury-containing compounds, and wherein said bromine-containing substance comprises elemental bromine

G) A method as in F) wherein said sorbent has about 0.1 to about 15 percent by weight bromine

H) A method as in F) or G) wherein said sorbent has an Acid Blue 80 Index below about 15 milligrams per gram of sorbent.

I) A method as in any of A)-H) wherein the injection rate is in the range of about 4 lb/MMacf to about 18 lb/MMacf.

J) A method as in any of Claims A)-I) wherein said cement plant further comprises a preheater tower, and wherein said sorbent is not injected before or into the preheater tower.

K) An apparatus for decreasing emissions from a cement plant comprising at least a particulate collection device and a stack, which apparatus comprises two or more beds in a series comprising

a first bed which is a moving bed, and

one or more remaining beds which are fixed beds, each fixed bed comprising at least one sorbent which is able to absorb at least one of mercury, hydrocarbons, and hydrochloric acid.

L) An apparatus as in K) wherein a fixed bed comprises a sorbent which is able to absorb mercury, and wherein said sorbent is an activated carbon sorbent, wherein said activated carbon sorbent has been treated with an effective amount of a bromine-containing substance for a sufficient time to increase the ability of the activated carbon to adsorb mercury and mercury-containing compounds, and wherein said bromine-containing substance comprises elemental bromine.

M) An apparatus as in L) wherein said sorbent has about 0.1 to about 15 percent by weight bromine.

N) An apparatus as in L) or M) wherein said sorbent has an Acid Blue 80 Index that does not exceed about 30 milligrams per gram of sorbent.

O) A method for reducing emissions of (i) particulate matter, and (ii) at least one of mercury, hydrochloric acid, and hydrocarbons from a cement plant comprising at least a particulate collection device and a stack, which method comprises

placing an apparatus of claim 10 after the particulate collection device of the cement plant and before the stack of the cement plant such that a gas stream can enter and exit said apparatus; and

allowing a gas stream from the particulate collection device to travel through said apparatus to the stack.

P) A method as in O) wherein the apparatus comprises a fixed bed comprising a sorbent which is able to absorb mercury, and wherein said sorbent is an activated carbon sorbent, wherein said activated carbon sorbent has been treated with an effective amount of a bromine-containing substance for a sufficient time to increase the ability of the activated carbon to adsorb mercury and mercury-containing compounds, and wherein said bromine-containing substance comprises elemental bromine

Q) A method as in P) wherein said sorbent has about 0.1 to about 15 percent by weight bromine

R) A method as in P) or Q) wherein said sorbent has an Acid Blue 80 Index that does not exceed about 30 milligrams per gram of sorbent.

Components referred to by chemical name or formula anywhere in the specification or claims hereof, whether referred to in the singular or plural, are identified as they exist prior to coming into contact with another substance referred to by chemical name or chemical type (e.g., another component, or a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A method for reducing mercury emissions from a cement plant comprising at least a kiln and a particulate collection device, which method comprises injecting a powdered activated carbon sorbent into a gas stream of said cement plant at one or
more points after the kiln and before the particulate collection device of said cement plant, with the proviso that the sorbent does not travel through the kiln,
wherein said activated carbon has an Acid Blue 80 Index of less than about 30 milligrams per gram of sorbent prior to any optional post-treatment with ozone or nitric acid.

2. A method as in claim 1 wherein said activated carbon sorbent has been treated with an effective amount of a bromine-containing substance for a sufficient time to increase the ability of the activated carbon to adsorb mercury and mercury-containing compounds.

3. A method as in claim 2 wherein said bromine-containing substance comprises elemental bromine and/or hydrogen bromide.

4. A method as in any of claim 2 or 3 wherein said sorbent has about 0.1 to about 15 percent by weight bromine

5. A method as in any of claims 1-3 wherein said sorbent has an Acid Blue 80 Index below about 15 milligrams per gram of sorbent.

6. A method as in claim 4 wherein said sorbent has an Acid Blue 80 Index below about 15 milligrams per gram of sorbent.

7. A method as in any of claims 1-3 wherein the sorbent is formed from anthracite or low-volatile bituminous coal.

8. A method as in claims 1-3 wherein the sorbent is formed from anthracite.

9. An apparatus for decreasing emissions from a cement plant comprising at least a particulate collection device and a stack, which apparatus comprises two or more beds in a series comprising
a first bed which is a moving bed, and
one or more remaining beds which are fixed beds, each fixed bed comprising at least one sorbent which is able to absorb at least one of mercury, hydrocarbons, and hydrochloric acid.

10. An apparatus as in claim 9 wherein a fixed bed comprises a sorbent which is able to absorb mercury, and wherein said sorbent is an activated carbon sorbent.

11. An apparatus as in claim 10 wherein said activated carbon sorbent has been treated with an effective amount of a bromine-containing substance for a sufficient time to increase the ability of the activated carbon to adsorb mercury and mercury-containing compounds.

12. An apparatus as in claim 11 wherein said bromine-containing substance comprises elemental bromine and/or hydrogen bromide.

13. An apparatus as in any of claim 11 or 12 wherein said sorbent has about 0.1 to about 15 percent by weight bromine

14. An apparatus as in any of claims 9-12 wherein said sorbent has an Acid Blue 80 Index that does not exceed about 30 milligrams per gram of sorbent.

15. A method for reducing emissions of (i) particulate matter, and (ii) at least one of mercury, hydrochloric acid, and hydrocarbons from a cement plant comprising at least a particulate collection device and a stack, which method comprises
placing an apparatus of claim 9 after the particulate collection device of the cement plant and before the stack of the cement plant such that a gas stream can enter and exit said apparatus; and
allowing a gas stream from the particulate collection device to travel through said apparatus to the stack.

16. A method as in claim 15 wherein the apparatus comprises a fixed bed comprising a sorbent which is able to absorb mercury, and wherein said sorbent is an activated carbon sorbent.

17. A method as in claim 16 wherein said activated carbon sorbent has been treated with an effective amount of a bromine-containing substance for a sufficient time to increase the ability of the activated carbon to adsorb mercury and mercury-containing compounds.

18. A method as in claim 17 wherein said bromine-containing substance comprises elemental bromine and/or hydrogen bromide.

19. A method as in any of claim 17 or 18 wherein said sorbent has about 0.1 to about 15 percent by weight bromine

20. A method as in any of claims 15-18 wherein said sorbent has an Acid Blue 80 Index that does not exceed about 30 milligrams per gram of sorbent.
